(19) United States
(12) Patent Application Publication
(10) Pub. No.: US 2025/0206244 A1
(43) Pub. Date: Jun. 26, 2025

(54) METHOD FOR CONVERTING REDUNDANCY POWER AND SYSTEM FOR THE SAME

(71) Applicants: HYUNDAI MOTOR COMPANY, Seoul (KR); KIA CORPORATION, Seoul (KR)

(72) Inventors: Soon Cheol HWANG, Hwaseong-si (KR); Byung Yoon CHOI, Hwaseong-si (KR); Jae Ho CHOI, Hwaseong-si (KR)

(73) Assignees: HYUNDAI MOTOR COMPANY, Seoul (KR); KIA CORPORATION, Seoul (KR)

(21) Appl. No.: 18/956,371

(22) Filed: Nov. 22, 2024

(30) Foreign Application Priority Data
Dec. 26, 2023 (KR) 10-2023-0190960

(51) Int. Cl. B60R 16/023; B60R 16/033

(52) U.S. Cl. CPC B60R 16/023; B60R 16/033

(57) ABSTRACT

A redundancy power conversion method includes converting a high voltage into a first low voltage or a second low voltage and supplying the converted first and second low voltages to at least two electrical loads that use the first or second low voltages as driving power, performing voltage conversion between the first and second low voltages in one direction according to a conversion request, determining whether a transmission process of the conversion request is normal, detecting a voltage state of the first or second low voltage converted, determining whether the detected voltage state of the first low voltage or the second low voltage is equal to or less than a preset threshold value, and performing an emergency supply of converting and supplying the other low voltage to at least two electrical loads that use a low voltage having a voltage state deviated from a preset threshold value as driving power.

### CROSS-REFERENCE TO RELATED APPLICATIONS

The present application claims priority to Korean Patent Application No. 10-2023-0190960, filed on Dec. 26, 2023, the entire contents of which is incorporated herein for all purposes by this reference.

### TECHNICAL FIELD

The present disclosure relates to a redundancy architecture of an autonomous vehicle that uses two different kinds of voltages, and more particularly, to a redundancy power conversion method for performing a normal redundancy power conversion supply even when an error or a damage occurs in a local communication network in a vehicle and a system for the same.

### BACKGROUND

In an automotive-related industry, a demand for improving a fuel economy has been continuously issued due to vehicle environmental requirements and high fuel prices, and various researches and developments are being performed according to above-described paradigm changes. In recent years, various types of researches and developments for improving the fuel economy are being performed in response to strengthened fuel economy regulations for vehicle companies, such as corporate average fuel economy (CAFE). As a part of this technological development, vehicle developments such as a battery EV and a Hybrid EV that use electrical energy are being actively examined.

In particular, a business for building infrastructure for commercialization of intelligent vehicles and expansion of an autonomous vehicle market cause a continuous investment on autonomous vehicles even in a domestic market. The autonomous vehicles that are capable of autonomously monitoring external information and recognizing a road condition to autonomously drive to a set destination even without an operation of a driver require additional power for various sensors and computing systems compared to general vehicles.

That is, since the autonomous vehicle is operated with a sensor, an internal MCU, and a steering system without intervention of the driver, a problem occurring in internal power may lead a major accident due to lack of power of various sensors, steering systems, or brakes.

A power generation system in a typical autonomous vehicle may generate short circuit or disconnection in a power system due to an internal defect or an external factor while the autonomous vehicle is driving, thereby generating a problem such that the vehicle stops while driving.

In order to solve the above-described problem, an autonomous vehicle system realizes a redundancy technology that has dual ECUs and dual power supply devices for emergency driving to a destination without the intervention of the driver although a failure occurs.

The above-described redundancy technology is being developed in various types according to characteristics for each vehicle manufacturing company. Among the various types, a manufacturing company that uses both a first operating voltage 24V and a second operating voltage 12V has a redundancy architecture as illustrated in FIG. 1.

When components in FIG. 1 are briefly described for each reference numeral, reference numeral 10 denotes a high voltage junction box (hereinafter, referred to as HV J/BOX) for distributing a high voltage supplied from a main battery (not shown).

Also, each of reference numerals 21 and 22 denotes a power conversion controller that converts the high voltage supplied from the HV J/BOX 10 into a low voltage. A first low DC-DC converter (LDC) 21 converts the high voltage into a low voltage of 12V and outputs the converted low voltage, and the second LDC 22 converts the high voltage into a low voltage of 24V and outputs the converted low voltage.

Also, each of reference numerals 31 and 32 denotes an active junction block (AJB) including a back to back switch (B2B) (no reference numeral). The B2B represents a switch having a function of detecting and blocking a power fail. The reference numeral 31 is dedicated to 12V, and the reference numeral 32 is dedicated to 24V.

Also, reference numeral 40 denotes a redundancy power converter (RPC) that is a bidirectional power conversion controller for 12V and 24V.

Also, each of reference numerals 51 and 52 denotes a sub-battery modules (SBM) including a low-voltage battery and an intelligent battery sensor (IBS) that detects a state of the low-voltage battery. The reference numeral 51 is dedicated to 12V, and the reference numeral 52 is dedicated to 24V.

Also, reference numeral 60 is a power-net domain controller (PDC) that distributes introduced 12V or 24V power to electrical loads denoted by reference numerals 81 and 82.

Also, each of reference numerals 71 and 72 denotes a load (a brake, a control unit, a steering wheel, etc.) related to an operation of a vehicle.

As illustrated in FIG. 1, the power system that is capable of simultaneously supplying 12V and 24V power to a low-voltage power network of a commercial vehicle. When a general power (expressed by a solid line) is diagnosed as a failure state by a function for each component, the power system blocks supply of failure power and provide redundancy power.

Here, when a second LDC 22 malfunctions or fails not to perform a normal supply of 24V, the second AJB 32 requests a conversion signal to the RPC 40 through a local communication network in the vehicle as illustrated in FIG. 1. Here, the conversion request signal in FIG. 1 illustrates only a signal line requested from the second AJB 32 for convenience of description.

Accordingly, the RPC 40 converts the 12V power supplied through the first AJB 31 into the 24V power and supplies the converted 24V power to the second AJB 32, and the second AJB 32 supplies the 24V power supplied from the RPC 40 components connected to a rear end thereof, which are denoted by reference numerals 72, 52, and 60.

When an error or a failure occurs in a local communication network in a vehicle in the above-described typical redundancy technology, the conversion request signal may not be correctly transmitted to the RPC 40 to prevent the RPC 40 from performing the power conversion, which causes a significant limitation on safety of the vehicle.

### SUMMARY

The present disclosure is intended to solve the above-described problems.

The present disclosure provides a redundancy power conversion method and a system for the same, and more particularly, to a redundancy power conversion method that performs normal redundancy power conversion supply even when an error or a failure occurs in a local communication network in a vehicle in a redundancy architecture of an autonomous vehicle that uses two different kinds of voltages.

An embodiment of the present disclosure provides a method of supplying power in a vehicle, the method including converting a high voltage into a first low voltage or a second low voltage and supplying the converted first or second low voltages to at least two electrical loads that use the first low voltage or the second low voltage as driving power, performing voltage conversion between the first low voltage and the second low voltage according to a conversion request, determining whether a transmission process of the conversion request is normal, detecting a voltage state of the first low voltage or the second low voltage converted in the supplying to the at least two electrical loads when abnormality is determined in the determining of whether the transmission process of the conversion request is normal, determining whether the detected voltage state of the first low voltage or the second low voltage is equal to or less than a preset threshold value, and performing a supply of power of one voltage converted from the other voltage among the first low voltage and the second low voltage to the electrical loads that use the one voltage as the driving power when it is determined that the detected voltage state of the one voltage is equal to or less than the preset threshold value.

In an embodiment, the determining of whether the transmission process of the conversion request is normal may include determining whether a communication line through which the conversion request is transmitted is normal.

In an embodiment, the determining of whether the transmission process of the conversion request is normal may include determining whether a subject that generates the conversion request is normal.

In an embodiment, the determining of whether the detected voltage state of the first low voltage or the second low voltage is equal to or less than the preset threshold value may include determining whether the first low voltage is maintained below a first threshold value for more than a preset time.

In an embodiment, the first threshold value may comprise 12.4V.

In an embodiment, the performing of a supply of power may include converting the second low voltage into the first low voltage and supplying the converted first low voltage to the electrical loads that use the first low voltage as the driving power when it is determined that the first low voltage is maintained below the first threshold value for more than the preset time.

In an embodiment, the determining of whether the detected voltage state of the first low voltage or the second low voltage is equal to or less than the preset threshold value may include determining whether the second low voltage is maintained below a second threshold value for more than a preset time.

In an embodiment, the second threshold value may comprise 24.8V.

In an embodiment, the performing of the emergency supply may include converting the first low voltage into the second low voltage and supplying the converted second low voltage to the electrical loads that use the second low voltage as the driving power when it is determined that the second low voltage is maintained below the second threshold value for more than a preset time.

In an embodiment of the present disclosure, a power supply system includes a first low DC-DC converter (LDC) that converts a high voltage of a main battery into a first low voltage and outputs the converted first low voltage, a second LDC that converts the high voltage of the main battery into a second low voltage and outputs the converted second low voltage, a first power distributor comprising a first built-in back to back switch (B2B), which receives the first low voltage output from the first LDC and supplies the received first low voltage to a first electrical load, a second power distributor comprising a second built-in B2B, which receives the second low voltage output from the second LDC and supplies the received second low voltage to a second electrical load, and a bidirectional converter that converts one voltage among the first low voltage output from the first LDC and the second low voltage output from the second LDC into the other voltage according to a power conversion request signal generated by the first power distributor or the second power distributor and supplies the one voltage to the first power distributor or the second power distributor that generates the power conversion request signal, wherein the bidirectional converter is configured to determine whether a transmission process of the power conversion request signal is normal, detect a voltage state of the first low-voltage or the second low-voltage when it is determined that the transmission process is not normal, and supply power of one voltage converted from the other voltage among the first low voltage and the second low voltage to the electronic loads that use the one voltage as the driving power, the one voltage being determined as one which is detected below a preset threshold value among the first low voltage and the second low voltage.

In an embodiment, the bidirectional converter may determine whether the communication line through which the power conversion request signal is transmitted is normal.

In an embodiment, the bidirectional converter may determine whether the first power distributor or the second power distributor is normally operated.

In an embodiment, the bidirectional converter may convert the second low voltage into the first low voltage and supplies the converted low voltage to the electrical loads that use the first low voltage as the driving power when the first low voltage is maintained below a first preset threshold for more than a preset time.

In an embodiment, the bidirectional converter may convert the first low voltage into the second low voltage and supplies the converted low voltage to the electrical loads that use the second low voltage as the driving power when the second low voltage is maintained below a second preset threshold for more than a preset time.

### BRIEF DESCRIPTION OF THE DRAWINGS

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, the same reference numerals refer to the same or equivalent parts of the present disclosure throughout the several figures of the drawing.

FIG. 1 is a view illustrating an example of a typical redundancy architecture of a vehicle, in which electrical loads using 12V power and 24V power are mixed.

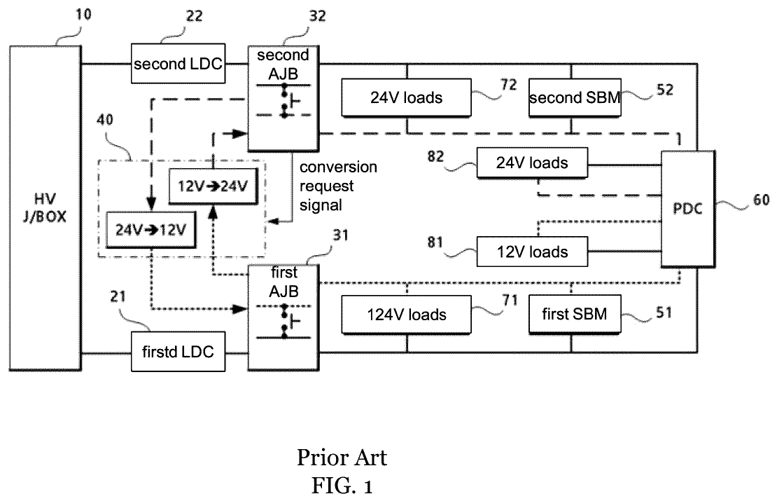

FIG. 2 is a view illustrating an example of a configuration of a system to which a redundancy power conversion method according to an embodiment of the present disclosure is applied.

FIG. 3 is a flowchart for explaining an example of the redundancy power conversion method according to an embodiment of the present disclosure.

### DETAILED DESCRIPTION

Since the present disclosure may have diverse modified embodiments, preferred embodiments are illustrated in the drawings and are described in the detailed description of the disclosure. However, this does not limit the present disclosure within the specific embodiments and it should be understood that the present disclosure covers all the modifications, equivalents, and replacements within the idea and technical scope of the present disclosure.

In this specification, the suffixes “module” and “unit” are used merely for nominal distinction between components and should not be interpreted as implying that the components are physically or chemically separated or that they can be separated.

It will be understood that although the terms of “first” and “second” are used herein to describe various elements, these elements should not be limited by these terms. These terms may be used solely to differentiate one component from another in name, and their sequential meanings are understood through the context of the description rather than by the names themselves.

The term “and/or” is used to include all possible combinations of the listed items. For example, “A and/or B” includes all three cases of “A”, “B”, and “A and B”.

It will also be understood that when an element is referred to as being “connected to” or “engaged with” another element, it can be directly connected to the other element, or intervening elements may also be present.

In the following description, the technical terms are used only for explaining a specific exemplary embodiment while not limiting the present disclosure. The terms of a singular form may include plural forms unless referred to the contrary. The meaning of ‘include’ or ‘comprise’ specifies a property, a region, a fixed number, a step, a process, an element and/or a component but does not exclude other properties, regions, fixed numbers, steps, processes, elements and/or components.

Unless terms used in the present disclosure are defined differently, the terms may be construed as meaning known to those skilled in the art. Terms that are generally used and have been in dictionaries should be construed as having meanings matched with contextual meanings in the art. In this description, unless defined clearly, terms are not ideally, excessively construed as formal meanings.

Also, the terms unit, control unit, control device, or controller are widely used to name devices that control specific functions and do not refer to a generic functional unit. Also, the devices denoted by the names may include a communication device that communicates with another controller or sensor to control the corresponding function, a computer-readable recording medium that stores an operation system, a logic command, and input/output information, and at least one processor that performs determinations, decisions, and calculations required for function control.

On the other hand, the processor may include semiconductor integrated circuits and/or electronic elements that perform at least one or more of comparisons, determinations, calculations, and decisions to achieve programmed functions. For example, the processor may be a computer, a microprocessor, CPU, ASIC, an electronic circuitry (logic circuits), or a combination thereof.

Also, the computer readable recording medium (or memory) includes all sorts of data storage devices that store computer readable data. For example, the computer readable recording medium may include at least one of a flash memory type, hard disk type, micro type, card type (e.g., secure digital (SD) card) or eXtream digital (XD) type memory and a random access memory (RAM), static RAM (SRAM), read-only memory (ROM), programmable ROM (PROM), electrically erasable PROM (EEPROM), magnetic RAM (MRAM), magnetic disk, or optical disk type memory.

These recording media may be electrically connected to the processor, and the processor may read data from and write data to the recording media. The recording media and the processor may be integrated with each other or physically separated from each other.

Hereinafter, a method for converting redundancy power (hereinafter, referred to as a redundancy power conversion method) according to an embodiment of the present disclosure and a system for the same will be described with reference to the accompanying drawings.

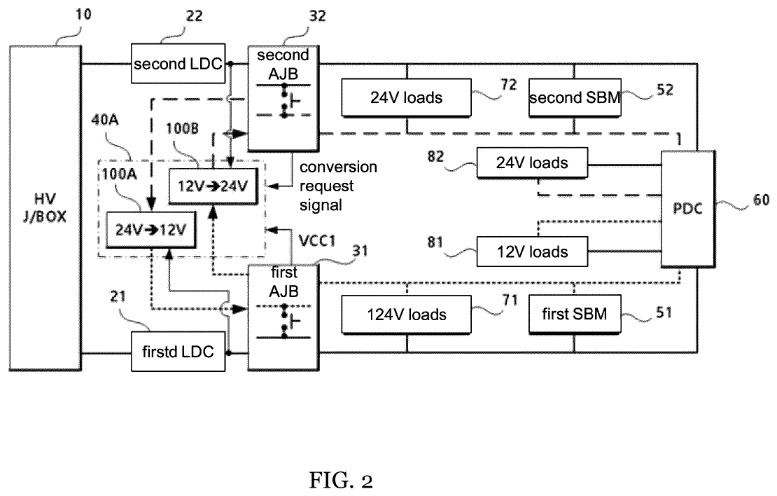

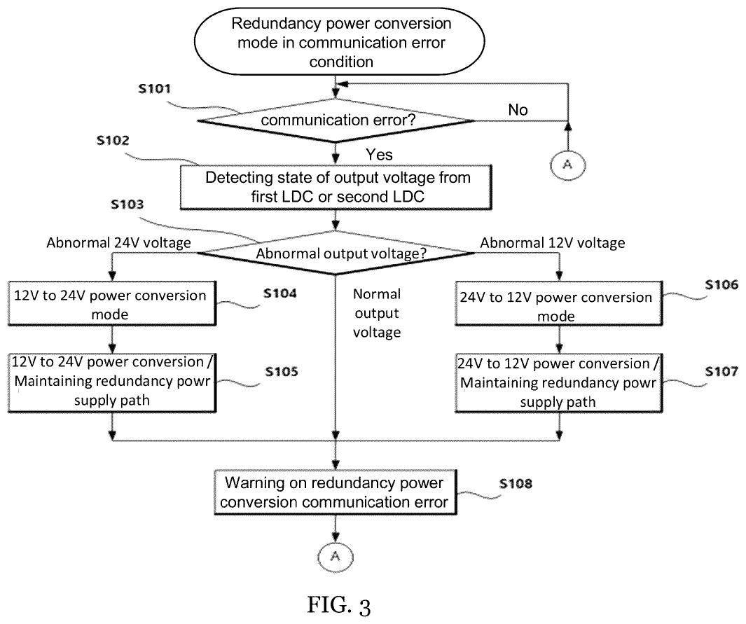

FIG. 2 is a view illustrating an example of a configuration of a system to which the redundancy power conversion method according to an embodiment of the present disclosure is applied, and FIG. 3 is a flowchart for explaining an example of the redundancy power conversion method according to an embodiment of the present disclosure.

As illustrated in FIG. 2, a system, to which the redundancy power conversion method according to an embodiment of the present disclosure is applied, includes a high voltage junction box (HV J/BOX), a first low DC-DC converter (LDC) 21, a second LDC 22, a first active junction block (AJB) 31 as an exemplary embodiment of a first power distributor, a second AJB 32 as an exemplary embodiment of a second power distributor, and a redundancy power converter (RPC) 40A as an exemplary embodiment of a bidirectional converter.

The high voltage junction box (HV J/BOX) 10 distributes a high voltage supplied from a main battery (not shown).

The first low DC-DC converter (LDC) 21 converts the high voltage supplied from the HV J/BOX 10 into a first low voltage and outputs the converted first low voltage.

The second LDC 22 converts the high voltage supplied from the HV J/BOX 10 into a second low voltage and outputs the converted second low voltage.

The first active junction block (AJB) 31 includes a first built-in back to back switch (B2B), which receives the first low voltage output from the first LDC 21 and supplies the received first low voltage to an electrical load connected to a rear end thereof.

The second AJB 32 includes a second built-in B2B, which receives the second low voltage output from the second LDC 22 and supplies the received second low voltage to an electrical load connected to a rear end thereof.

The redundancy power converter (RPC) 40A converts a low voltage output from the first LDC 21 or the second LDC 22 into the other low voltage according to a power conversion request signal generated by the first AJB 31 or the second AJB 32 and supplies the converted low voltage to the first AJB 31 or the second AJB 32 that generates the power conversion request signal.

Here, the RPC 40A includes a second low-voltage conversion unit 100B that receives a 12V low voltage from the first AJB 31, converts the received 12V low voltage into 24V low voltage, and supplies the converted 24 low voltage to the second AJB 32 when it is determined that the second LDC 22 is not normally operated by detecting a state of the 24V low voltage output from the second LDC 22 in real-time, and a first low-voltage conversion unit 100A that receives a 24V low voltage from the second AJB 32, converts the received 24V low voltage into 12V low voltage, and supplies the converted 12 low voltage to the first AJB 31 when it is determined that the first LDC 21 is not normally operated by detecting a state of the 12V low voltage output from the first LDC 21 in real-time.

Also, the RPC 40A determines whether a process of transmitting power conversion request signals VCC1 and VCC2 is normal based on two perspectives.

That is, the RPC 40A determines whether a communication line through which the power conversion request signals VCC1 and VCC2 are transmitted is normal by using a communication line checking technology (impedance checking method) at each preset time.

Thereafter, when it is determined that the communication line is abnormal, the first low-voltage conversion unit 100A and/or the second low-voltage conversion unit 100B are driven.

Also, when it is determined that the communication line is normal by using a typical communication line checking technology at each preset time, it is determined whether the first AJB 31 or the second AJB 32 that generates the power conversion request signal VCC1 or VCC2 is normally operated based on a state of a typical confirmation request signal or response signal.

In addition, each of reference numerals 51 and 52 denotes a sub-battery modules (SBM) including a low-voltage battery and an intelligent battery sensor (IBS) that detects a state of the low-voltage battery. The reference numeral 51 is dedicated to 12V, and the reference numeral 52 is dedicated to 24V.

Also, reference numeral 60 is a power-net domain controller (PDC) that distributes introduced 12V or 24V power to electrical loads denoted by reference numerals 81 and 82.

Also, each of reference numerals 71 and 72 denotes a load (a brake, a control unit, a steering wheel, etc.) related to an operation of a vehicle.

Thus, as illustrated in FIG. 2, a redundancy power conversion process according to an embodiment of the present disclosure in a communication error condition in a state of having a redundancy power system capable of simultaneously supplying both 12V power and 24V power to a low-voltage power network will be described below with reference to FIG. 3.

In step S101, the RPC 40A determines whether the first AJB 31 and/or the second AJB 32 are normally operated or whether the communication line through which the power conversion request signals VCC1 and VCC2 are transmitted is normal. When abnormality is determined, the step S101 proceeds to step S102.

In step S102, the first low-voltage conversion unit 100A and/or the second low-voltage conversion unit 100B are driven. Through this, a state of an output voltage of the first LDC 21 and/or the second LDC 22 is detected.

That is, it is inspected whether a voltage output from the second LDC 22 maintains a voltage state of 24.8V and whether a voltage output from the first LDC 21 maintains a voltage state of 12.4V.

Thus, it is determined in step S103 which of the first LDC 21 and the second LDC 22 has an abnormal output voltage based on the voltage state inspected through a process of the step S102.

When the voltage output from the second LDC 22 is maintained below 24.8V for a predetermined time (e.g., 5 seconds or 10 seconds), it is determined that the second LDC 22 is in an abnormal state.

Also, when the voltage output from the first LDC 21 is maintained below 12.4V for a predetermined time (e.g., 5 seconds or 10 seconds), it is determined that the first LDC 21 is in an abnormal state.

When it is determined in step S103 that both the first LDC 21 and the second LDC 22 are normally operated, the step S103 proceeds to step S108, so that a warning is issued to a user that a communication error exists in the redundancy power conversion system.

On the other hand, when it is determined in step S103 that the voltage output from the second LDC 22 is maintained below 24.8V for a predetermined time (e.g., 5 seconds or 10 seconds) and thus the second LDC 22 is in an abnormal state, the step S103 proceeds to step S104 to perform a redundancy mode that converts the first low voltage to the second low voltage.

Thus, through step S105, the first low-voltage conversion unit 100A is normally driven to convert the 12V voltage introduced from the first AJB 31 into the 24V voltage and then transmit the converted 24V voltage to the second AJB 32, thereby supplying the transmitted 24V voltage as driving power to 24V dedicated electrical loads denoted by reference numerals 72 and 82.

Unlike the above-described process, when it is determined in step S103 that the voltage output from the first LDC 21 is maintained below 12.4V for a predetermined time (e.g., 5 seconds or 10 seconds) and thus the first LDC 21 is in an abnormal state, the step S103 proceeds to step S106 to perform a redundancy mode that converts the second low voltage to the first low voltage.

Thus, through step S107, the second low-voltage conversion unit 100B is normally driven to convert the 24V voltage introduced from the second AJB 3 into the 12V voltage and then transmit the converted 12V voltage to the first AJB 31, thereby supplying the transmitted 12V voltage as driving power to 12V dedicated electrical loads denoted by reference numerals 71 and 81.

In an exemplary embodiment, the B2B may comprise IC (Integrated Circuit) and a plurality of field effect transistors (FETs) such that the IC controls the voltage at the gate sides of the FETs to control the bidirectional flow of current through the FETs, the AJB may comprise a microcontroller unit, current/voltage sensors, one or more B2Bs, and a relay switching on or of a flow of current to each electric component, and the RPC may comprises a microcontroller unit, a boost/buck converting circuit, and one or more B2Bs connected between the converting circuit and the side of higher voltage to be converted.

In general, a converter controller for power conversion is operated in a FAULT mode that does not perform power conversion when a communication failure occurs. However, when the redundancy power conversion method and the system for the same according to the present disclosure, which is operated as described above to realize power stability of the autonomous vehicle, are provided, the converter may determine the power failure by itself and perform the power conversion without a communication command.

According to one embodiment of the present disclosure, the redundancy power conversion method and the system for the same are provided. In general, the converter controllers for power conversion are configured to enter a FAULT mode that does not perform power conversion when the communication failure occurs. However, to realize stability in power of the autonomous vehicles, the converter itself may detect the power failure and perform the power conversion without communication commands.

Although the embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of supplying power in a vehicle, the method comprising:
converting, by a converter, a high voltage into a first low voltage or a second low voltage, and supplying the converted first or second low voltages to at least two electrical loads that use the first low voltage or the second low voltage as driving power;
performing voltage conversion between the first low voltage and the second low voltage according to a conversion request;
determining whether a transmission process of the conversion request is normal;
detecting a voltage state of the first low voltage or the second low voltage converted in the supplying to the at least two electrical loads when an abnormality is determined during the determination of whether the transmission process of the conversion request is normal;
determining whether the detected voltage state of the first low voltage or the second low voltage is equal to or less than a preset threshold value; and
performing a supply of power of a third voltage converted from a fourth voltage among the first low voltage and the second low voltage to the at least two electrical loads that use the third voltage as the driving power upon a determination that the detected voltage state of the third voltage is equal to or less than the preset threshold value.

2. The method of claim 1, wherein determining whether the transmission process of the conversion request is normal comprises determining whether a communication line through which the conversion request is transmitted is normal.

3. The method of claim 1, wherein determining whether the transmission process of the conversion request is normal comprises determining whether a subject that generates the conversion request is normal.

4. The method of claim 1, wherein determining whether the detected voltage state of the first low voltage or the second low voltage is equal to or less than the preset threshold value comprises determining whether the first low voltage is maintained below a first threshold value for more than a preset time.

5. The method of claim 4, wherein the first threshold value comprises 12.4V.

6. The method of claim 4, wherein performing a supply of power comprises converting the second low voltage into the first low voltage and supplying the converted first low voltage to the at least two electrical loads that use the first low voltage as the driving power upon a determination that the first low voltage is maintained below the first threshold value for more than the preset time.

7. The method of claim 1, wherein determining whether the detected voltage state of the first low voltage or the second low voltage is equal to or less than the preset threshold value comprises determining whether the second low voltage is maintained below a second threshold value for more than a preset time.

8. The method of claim 7, wherein the second threshold value comprises 24.8V.

9. The method of claim 7, wherein performing the emergency supply comprises converting the first low voltage into the second low voltage and supplying the converted second low voltage to the at least two electrical loads that use the second low voltage as the driving power upon a determination that that the second low voltage is maintained below the second threshold value for more than the preset time.

10. A power supply system of a vehicle comprising:
a first low DC-DC converter (LDC) configured to convert a high voltage of a main battery into a first low voltage and to output the first low voltage;
a second LDC configured to convert the high voltage of the main battery into a second low voltage and to output the second low voltage;
a first power distributor comprising a first built-in back to back switch (B2B), configured to receive the first low voltage output from the first LDC and to supply the received first low voltage to a first electrical load;
a second power distributor comprising a second built-in B2B, configured to receive the second low voltage output from the second LDC and to supply the received second low voltage to a second electrical load; and
a bidirectional converter configured to convert a third voltage among the first low voltage output from the first LDC and the second low voltage output from the second LDC into a fourth voltage according to a power conversion request signal generated by the first power distributor or the second power distributor, and to supply the third voltage to the first power distributor or the second power distributor that generates the power conversion request signal;
wherein the bidirectional converter is configured to determine whether a transmission process of the power conversion request signal is normal, to detect a voltage state of the first low-voltage or the second low-voltage upon a determination that the transmission process is not normal, and to supply power of the third voltage converted from the fourth voltage among the first low voltage and the second low voltage to the first and second electrical loads that use the one voltage as the driving power, the third voltage being below a preset threshold value among the first low voltage and the second low voltage.

11. The method of claim 10, wherein the bidirectional converter is further configured to determine whether the communication line through which the power conversion request signal is transmitted is normal.

12. The method of claim 10, wherein the bidirectional converter is further configured to determine whether the first power distributor or the second power distributor is normally operated.

13. The method of claim 10, wherein the bidirectional converter is further configured to convert the second low voltage into the first low voltage and to supply the converted low voltage to the first and second electrical loads that use the first low voltage as the driving power when the first low voltage is maintained below a first preset threshold for more than a preset time.

14. The method of claim 10, wherein the bidirectional converter is further configured to convert the first low voltage into the second low voltage and to supply the converted low voltage to the first and second electrical loads that use the second low voltage as the driving power when the second low voltage is maintained below a second preset threshold for more than a preset time.
